(19) United States
(12) Patent Application Publication
(10) Pub. No.: US 2014/0187240 A1
(43) Pub. Date: Jul. 3, 2014

(54) System and Method for Automatically Switching Based on Cellular Mobile Communication Network and Internet Protocol (IP) Network

(71) Applicant: Shanzhen Chen, Ankang Shaanxi (CN)

(72) Inventor: Shanzhen Chen, Ankang Shaanxi (CN)

(21) Appl. No.: 14/118,316

(22) PCT Filed: May 18, 2011
(86) PCT No.: PCT/CN11/00869

§ 371 Date: Dec. 19, 2013

(51) Int. Cl. H04W 4/12; H04W 88/06

(52) U.S. Cl. CPC H04W 4/12; H04W 88/06
USPC 455/426.1

(57) ABSTRACT

A communication method for automatically switching between cellular networks and IP networks includes following steps. A mobile phone number is used as an user account. A sending user inputs or selects the user account or the mobile phone number of a receiving user on a sending client to send a message to the receiving user. If there is an user account corresponding to the mobile phone number of the receiving user registered on a server and the user account is on line, the sending client sends a message to the server via the IP networks, and the server transfers the message to a receiving client via the IP networks. If there is no user account corresponding to the mobile phone number of the receiving user registered on the server, the sending client directly sends a short message to the mobile phone number of the receiving user via the cellular networks.

### BACKGROUND

1. Technical Field

The present disclosure relates to network communications, and more particularly to an automatic switching and failover communication system between a cellular mobile communication network and an IP network, and a method implementing the automatic switching communication system.

2. Description of Related Art

Short message, as a popular communication mode, offers transmission of real-time short message between mobile devices. Most of mobile phone users use a mobile phone to send short messages. However, service fee of the short messages of most operators is expensive. Instant messaging software in the mobile phones gains popularity rapidly as smart phones takes over market shares. Instant messaging software can deliver short messages among users registered on the same instant messaging network, at minimum or zero cost. However, it cannot deliver message to user not registered on the particular IM network.

In prior technologies, many instant messaging softwares, such as Fetion of China Mobile, Wechat of Tencent and Windows Live Messenger are capable of offering inexpensive or free service for short message communication. However, they cannot send message between users without registration. In most of the instant messaging softwares, such as Wechat of Tencent and Windows Live Messenger, the user must manually register an account as identification when sending messages. Some of the instant messaging softwares can deliver messages between a computer and a mobile phone. But when User A use both an IM software on a computer and short message on the cell phone to communicate with User B, the context of the conversation is scatters on both devices and software applications. This makes it very inconvenient for User A to keep track and search through the conversation.

FaceTime of Apple Inc. is capable of using a mobile phone number as an identification for an video call, but the mobile phone number is not used as an identifier for short message and the voice calls. In addition, FaceTime is used only on IP networks, and if the user on the other side does not use FaceTime or the other user is offline, Face Time cannot automatically switch to other communication mode automatically, such as traditional voice call over cellular network or short message service over cellular network.

Therefore, a need exists in the industry to overcome the described problems.

### SUMMARY

In order to solve the problem described above, the present disclosure offers a communication system and method for automatic switching between cellular mobile communication networks and IP networks.

The method for automatic switching between cellular mobile communication networks and the IP networks includes the following steps.

In step 1, a mobile phone number or a result calculated from the mobile phone number is used as the identifier of a client or a part of the identifier of the client. The client refers to the software or apparatus for sending and receiving messages on the user's behalf.

In step 2, a sending user inputs or selects a mobile phone number of a receiving user on the sending client to send a message to the receiving user. If the mobile phone number of the receiving user is registered on the server and is the receiving user's client is on-line, the sending client sends an instant message to the server via the IP network, and the server transfers the instant message to the receiving client. If the mobile phone number of the receiving user is registered on the server or is registered on the server but currently offline, the sending client directly sends a short message to the mobile phone number of the receiving user via the cellular mobile communication network.

In one embodiment, between the step 1 the step 2, the automatic switching communication method further includes following steps.

The client registers or logins automatically and adds mobile phone numbers stored on the phone as contacts stored in the database.

A push channel is established over the IP network between the client and server.

After the receiving client receives the instant message, the receiving client displays the mobile phone number of the sending user and the message in a fashion similar to how the client displays received short message over cellular networks.

The step of the client registration and login automatically includes following steps.

The client establishes an (encrypted) IP communication channel with the server, and the client and the server authenticate each other.

The client determines whether there is an authorization token on the client or and registration entry on the server.

The client sends a registration request to the server, and receives the authentication token representing the registration entry from the server, when there is an authentication token registration entry for the client.

The client sends a login request to the server, and the login request includes the authentication token, when there is no authentication token for the client.

The server verifies the authentication token and informs the client to login successfully.

In one embodiment, the step of the client sending the registration request to the server includes following steps.

The client sends the short message to the server via the cellular mobile communication network, and the short message includes a temporary key.

The client sends the registration request to the server via the IP network, and the registration request includes the mobile phone number.

The server and the client certificates with each other, and the server agrees certification of the client.

The server accesses or generates the authentication token corresponding to the mobile phone number, encrypts the authentication token by use of the temporary key, and sends the encrypted authentication token to the client via the IP network, and the client decrypts the encrypted authentication token to get the authentication token by use of the temporary key.

In one embodiment, the step of the client sending the registration request to the server includes following steps.

The client sends the registration request to the server via the IP network, and the registration request includes the mobile phone number.

The server sends the short message to the client via the cellular mobile communication network, and the short message includes a temporary key.

The server and the client certificate with each other and the server agrees certification of the client.

The server accesses or generates the authentication token corresponding to the mobile phone number, and encrypts the authentication token by use of the temporary key, and sends the encrypted authentication token to the client via the IP network, and the client decrypts the encrypted authentication token to get the authentication token by use of the temporary key.

In one embodiment, the step of the server verifies the authentication token and informs the client to login successfully includes following steps.

The server verifies the authentication token consistence with a digital signature of a certificate of the client with an encrypted connection with the server.

The server and the client certificates with each other and the server agrees the certification of the client.

The server verifies the authentication token, and informs the client to login successfully.

In one embodiment, the sending client writes the sent instant message on a sent message sheet of a database storing the short message of the mobile phone. The receiving client writes the received instant message on a received message sheet of the database.

In one embodiment, before the step of the sending client sending the short message to the receiving client via cellular mobile communication network, the communication method further includes step of the sending client reminding the sending user whether sending message generates message fee.

In one embodiment, the sent short message or the received short message are uploaded to the database of the server via the IP network.

In one embodiment, when a mobile terminal of the sending user or the receiving user can not access to the IP network, the client stores the uploading short message, and maintains an alignment for the uploading short message, and uploads the uploading short message to the server when the mobile terminal accesses to the IP network.

In one embodiment, the database of the server records the instant message transferred from the server, and stores the instant message transferred from the server and the short message uploaded from the receiving client as message history records.

In one embodiment, a website is connected to the server via the IP network, and the sending user sends instant message to the receiving user who has registered on the server and is on line via a web client.

In one embodiment, the user can view the message history records in the database of the server via a browser of the website.

In one embodiment, after the receiving user received the instant message or the short message from the sending user, the receiving user can select to reply message to the sending user. If the sending user is online, the receiving client replies to the sending client by use of the instant message; and if the sending user is offline, the receiving client replies to the sending client by use of the short message.

In one embodiment, the client updates online information of the contacts in real-time.

In one embodiment, the sending client and the receiving client can carry out a voice communication or a multimedia communication on the IP network.

In one embodiment, the sending client or the receiving client uploads the voice communication record and the data of multimedia message to the database of the server.

In one embodiment, transmission of voice communication data between the sending client and the receiving client is transferred by the server, or the voice communication data between the sending client and the receiving client is transmitted by way of a point to point mode.

The present disclosure provides an automatic switching communication system based on the cellular mobile communication network and the IP network. The communication system includes a client and a server, the client includes a sending client and a receiving client.

The client is configured for sending an instant message to the server when a receiving user registers on the server and is on line, and sending a short message to the mobile phone number of the receiving user when the receiving user has not registered on the server or the receiving user has registered on the server, but the receiving user is offline.

The server is configured for transmitting the instant message to the receiving client.

The mobile phone number or a result calculated from the mobile phone number is provided as an identifier of the client or a part of the identifier of the client.

In one embodiment, the client automatically registers and adds the mobile phone number as contacts, or the client automatically logins on the client and adds mobile phone number as contacts. A push channel is established between the client and the server on the IP network.

In one embodiment, the client is further configured for displaying a mobile phone number of a sending user with a displaying mode similar with a displaying mode of the received short message, after the client receives the instant message.

In one embodiment, the client is further configured for establishing an encrypted IP communication link with the server, and the client and server certificates with the server.

In one embodiment, the client is configured for determining whether there is an authentication token; and the client sends a registration and login request to the server if there is no authentication token, and the client logins on the server if there is the authentication token.

In one embodiment, the client is further configured for sending the short message to the server via the cellular mobile communication network when the client requests registration on the server, and the short message includes a temporary key. The client is configured for sending a registration request to the server via the IP network, and the registration request includes the mobile phone number. The client is further configured for certificating with the server. The client is configured for receiving encrypted authentication token transmitted from the IP network and getting the authentication token by decrypting the encrypted authentication token. The authentication token is accessed or generated by the server and corresponds to the mobile phone number, and the server encrypts the authentication token by the temporary key.

In one embodiment, the client is further configured for sending the registration request to the server via the IP network when the client requests registration on the server, and the registration request includes the mobile phone number. The client is further configured for receiving the short message transmitted from the server via the cellular mobile communication network. The short message includes the temporary key. The client is configured for certificating with the server. The client is configured for receiving the encrypted authentication token and decrypting the encrypted authentication token by the temporary key to get the authentication token. The authentication token is accessed or generated by the server and corresponds to the mobile phone number, and the server encrypts the authentication token by the temporary key.

In one embodiment, the server is configured for verifying the authentication token consistence with a digital signature of a certificate of the client with an encrypted connection with the server, and agreeing the certification of the client, verifying the authentication token, and informing the client to login successfully.

In one embodiment, the client is configured for writing the sent instant message on a sent message sheet of the database storing the short message of the mobile phone, and writing the received instant message on a received message sheet of the database.

In one embodiment, the client is configured for reminding the sending user whether sending message generates message fee before the sending client sending message to the receiving client via the cellular mobile communication network.

In one embodiment, the communication system further includes a database embedded in the server, and the client is configured for uploading the sent short message and the received short message to the database via the IP network.

In one embodiment, the client is further configured for storing the uploading short message, and maintaining an alignment for the uploading short message, when the IP network is not accessed, and the client is configured for uploading the short message to the server when the IP network is accessed.

In one embodiment, the database of the server is further configured for recording the instant message transferred from the server, and storing the instant message transferred from the server and the short message uploaded from the receiving client as message history records.

In one embodiment, the communication system further includes a website and a web client, the IP network is established between the website and the server, and the sending user sends instant message to the receiving user who has registered on the server and is on line via the web client.

In one embodiment, the user can view the message history records in the database of the server via a browser of the website.

In one embodiment, after the receiving client received the short message, if the sending user is online, the receiving client is configured for replying to the sending client by use of the instant message, or after the receiving client received the instant message, if the sending user is offline, the receiving client is configured for replying the sending client by use of the short message.

In one embodiment, the client is further configured for instantaneously updating online information of the contacts.

In one embodiment, the client is capable of carrying out a voice communication or a multimedia communication on the IP network.

In one embodiment, the client is further configured for uploading the voice communication records and the data of multimedia message to the database of the server.

In one embodiment, transmission of voice communication data between the sending client and the receiving client is transferred by the server, or the voice communication data between the sending client and the receiving client is transmitted by way of a point to point mode.

The present disclosure also provides a mobile terminal or a computer including the client of the automatic switching communication system as described above.

In the present disclosure, the mobile phone number is regarded as an user account, the client automatically registers and logins on the server, automatically adds new friends, and automatically uploads short message records on the server. The user can browse information on the web handily without registration and login on the server.

### BRIEF DESCRIPTION OF THE DRAWINGS

The details of the disclosure, both as to structure and operation, can be best understood by referring also to the accompanying drawings, in which like reference numbers and designations refer to like elements.

FIG. 1 is a schematic diagram of one embodiment of an automatic switching communication system based on a cellular mobile communication network and an IP network in accordance with the present disclosure.

FIG. 2 is a flow chart of one embodiment of registration and login of the automatic switching communication system in accordance with the present disclosure.

FIG. 3 is a flow chart of one embodiment of registration and login of a mobile phone in accordance with the present disclosure.

FIG. 4 is a flow chart of one embodiment of a server accepting registration and login of a client in accordance with the present disclosure.

FIG. 5 is a flow chart of another embodiment of registration and login of the automatic switching communication system in accordance with the present disclosure.

FIG. 6 is a flow chart of sending message based on the cellular mobile communication network and the IP network in accordance with the present disclosure.

FIG. 7 is a flow chart of the client receiving message in accordance with the present disclosure.

FIG. 8 is a schematic diagram of communication between online clients and communication between the online clients and users without registration in accordance with the present disclosure.

FIG. 9 is a schematic diagram of another embodiment of the automatic switching communication system based on the cellular mobile communication network and the IP network in accordance with the present disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

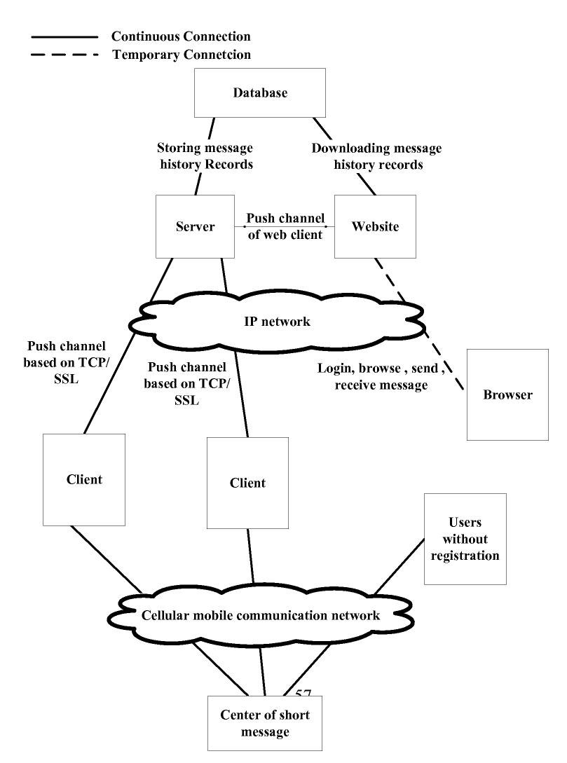

FIG. 1 is a schematic diagram of one embodiment of an automatic switching communication system based on a cellular mobile communication network and an IP network in accordance with the present disclosure. The automatic switching communication system includes a client, a server and a database embedded in the server. A first push channel based on Transmission Control Protocol (TCP)/Transport Layer Security (TLS), or Secure Socket Layer (SSL) is established between the client and the server. Message records of the server are stored in the database of the server.

In addition, a second push channel of a web client is established between the server and a website. The website is capable of downloading the message records from the database of the server. The client is capable of communicating with a short message center, a user without registration is capable of communicating with the short message center, and a browser is capable of communicating with the website.

In the embodiment, the client is a mobile phone client.

An automatic switching communication method based on the cellular mobile communication network and the IP network in accordance with the present disclosure, includes the following six steps which from step one to step six.

In step one, the mobile phone client registers and logins on the server automatically.

An instant messaging software generally requires a user to register a user name when the user uses the instant messaging software for the first time. The registered user is also required to offer a password of the user name later. The user is not required to register and login in the present disclosure. The mobile phone client checks if there is an authentication token granted by the server in the mobile phone client itself when the mobile phone runs. It indicates that the mobile phone client has not registered or the authentication token of the mobile phone client is lost when there isn't authentication token granted by the server in the mobile phone client itself. As a result, the mobile phone client starts a process of registration on the server.

A perfect embodiment of the process of registration or login is described as followings.

The mobile phone client sends a temporary key via a short message network of the mobile phone client. A short message with the temporary key arrives at the server via a short message gateway. The mobile phone client waits time (such as 60 seconds), and connects to the TCP/TLS or SSL via the IP network. Mutual Authentication is used for the connection between the mobile phone client and the TCP/TLS or SSL. That is, the mobile phone client only accepts the servers with legal certifications and the servers issuing the legal certification to right domain names. The server accepts any TLS certifications when the mobile phone client registers or logins for the first time, and the server only accepts the TLS certification corresponding to a mobile phone number of the mobile phone client and recorded on the server later. The mobile phone client sends a registration request or a login request to the server on the TLS link. The registration request or the login request includes the mobile phone number of the mobile phone client.

When the server receives the registration or the login request, if an account corresponding to the mobile phone number is not registered, the account corresponding to the mobile phone number is established and registered, and an authentication token is generated and stored in the server. If the mobile phone number has been registered, the mobile phone client logins and reads the authentication token. The server encrypts the authentication token via a temporary key in the short message sent by the mobile phone number of the mobile phone client corresponding to the authentication token, and the server sends the encrypted authentication token to the mobile phone client on the same one TLS link.

The short message of the mobile phone number of the mobile phone client ensures that only the mobile phone client corresponding to the mobile phone number decrypts the encrypted authentication token. After the mobile phone client decrypts the encrypted authentication token, the mobile phone client sends a decrypted authentication token to the server via the TLS link. The server confirms the registration of the mobile phone client, and records a digital signature of the TLS authorized certification of the user on the server as a digital signature list of the users allowable by the account corresponding to the mobile phone number. So that, the Playback Attack and the Man-in-the-middle attack are avoided. One mobile phone number can correspond to a plurality of digital signatures, so that the user can login on the server from a plurality of clients.

The process of login is described as followings.

When the mobile phone client logins later, the mobile phone client is only required to send the authentication token to the server to verify the identification of the mobile phone client on the TLS link. The server only accepts the client with the legal authentication token, and the client with consistence between the TLS certification and the mobile phone number of the mobile phone client.

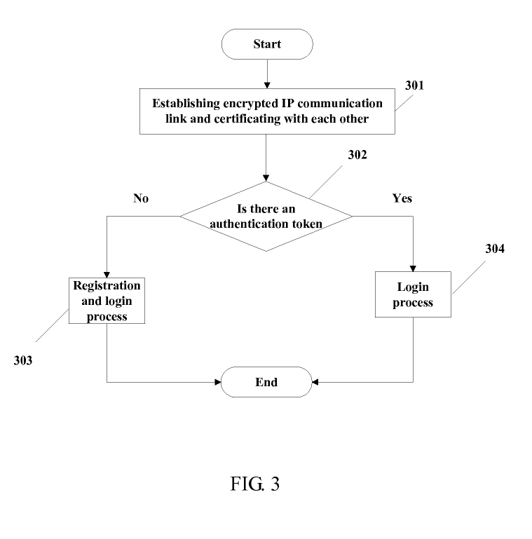

FIG. 2 is a flow chart of registration and login of the mobile phone client. In step 201, before registration and login of the mobile phone client on the server, the encrypted IP communication link (such as TTL/SSL) is established, and the mobile phone client and server certificates with each other. Steps 202, 203 and 204 show a flow chart of registration of the mobile phone client, and steps 205, 206 show a flow chart of login of the mobile phone client.

With reference to FIG. 2, the flow chart of registration of the mobile phone client includes following steps.

In step 202, the mobile phone client sends the temporary key to the server via the short message.

In step 203, the mobile phone client sends the registration request to the server, and the registration request includes the mobile phone number of the mobile phone client.

In step 204, the server sends the authentication token encrypted by the temporary key to the mobile phone client.

With reference to FIG. 2, the flow chart of login of the mobile phone client includes following steps.

In step 205, the client sends the login request to the server, and the login request includes the authentication token.

In step 206, the server informs the client to login successfully.

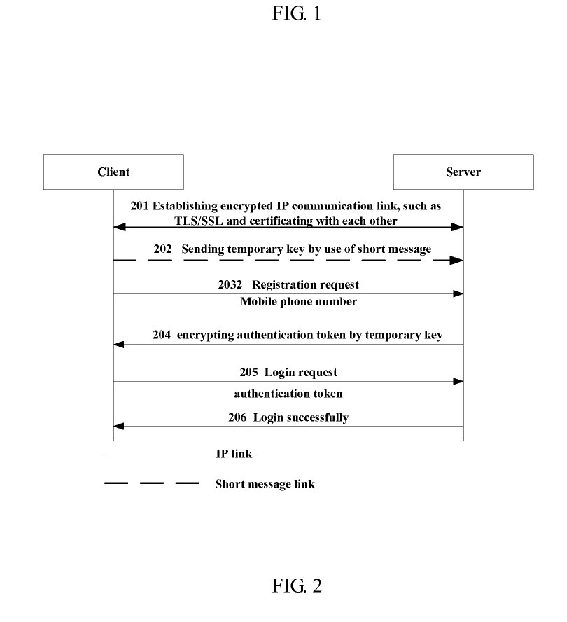

For the mobile phone client, a local dealing flow chart shown as FIG. 3, includes the following steps.

In step 301, after the mobile phone client starting up, an encrypted IP communication link is established between the mobile phone client and the server, and the mobile phone client and the server certificate with each other.

In step 302, the mobile phone client determines whether there is the authentication token.

In step 303, the processes of registration and login as described above are run, when there is no authentication token.

In step 304, the process of login as described above is run, when there is the authentication token.

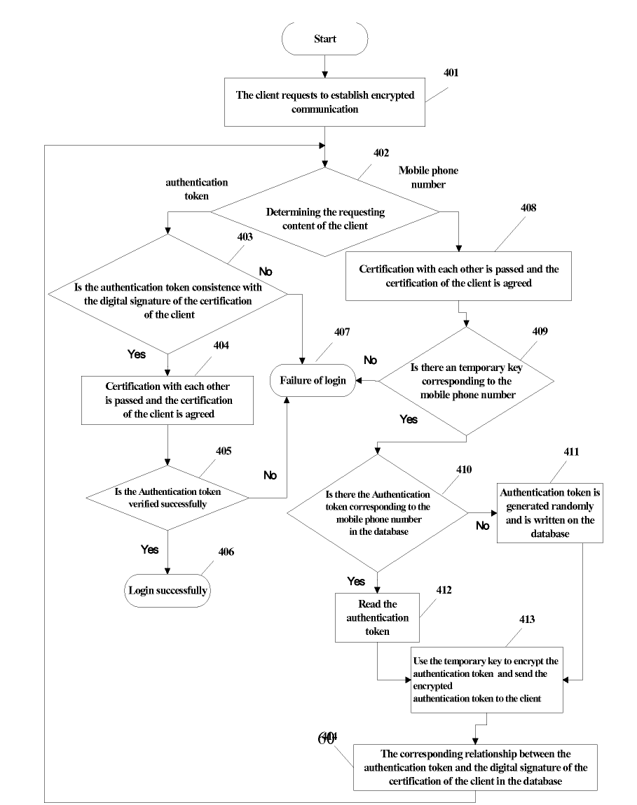

For the server, a local dealing flow chart shown as FIG. 4, includes the following steps.

In step 401, the mobile phone client requests to establish an encrypted link with the server.

In step 402, the server checks the requesting content of the mobile phone client.

In step 403, the server determines whether the authentication token correspond to the digital signature of the certification of the mobile phone client with the encrypted link, if the requesting content of the client is the authentication token.

In step 404, the server and the client certificate with each other, and the server agrees the certification of the client, when the authentication token corresponds to the digital signature of the certification of the mobile phone client with the encrypted link.

In step 405, the server determines whether the certification of the authentication token is successful.

In step 406, the mobile phone client logins successfully, when the certification of the authentication token is successful.

In step 407, the mobile phone client fails to login, when the authentication token does not correspond to the digital signature of the certification of the client with the encrypted link.

In step 408, the server and the client certificate with each other, and the server agrees with the certification of the client, when the requesting content of the client is the mobile phone number.

In step 409, the server determines whether there is the temporary key corresponding to the mobile phone number in the database, if there is no temporary key corresponding to the mobile phone number in the database, the client fails to login.

In step 410, the server determines whether there is the authentication token corresponding to the mobile phone number in the database, when there is the temporary key corresponding to the mobile phone number in the database of the server.

In step 411, a new authentication token is generated randomly and is written in the database if there is no authentication token corresponding to the mobile phone number in the database.

In step 412, the server reads the authentication token, when there is the authentication token corresponding to the mobile phone number in the database.

In step 413, the server encrypts the authentication token by the temporary key and sends the encrypted authentication token to the mobile phone client.

In step 414, the corresponding relationship between the digital certification of the mobile phone client and the authentication token is recorded in the database. The flow chart returns to the step 402, and is repeated to carry out.

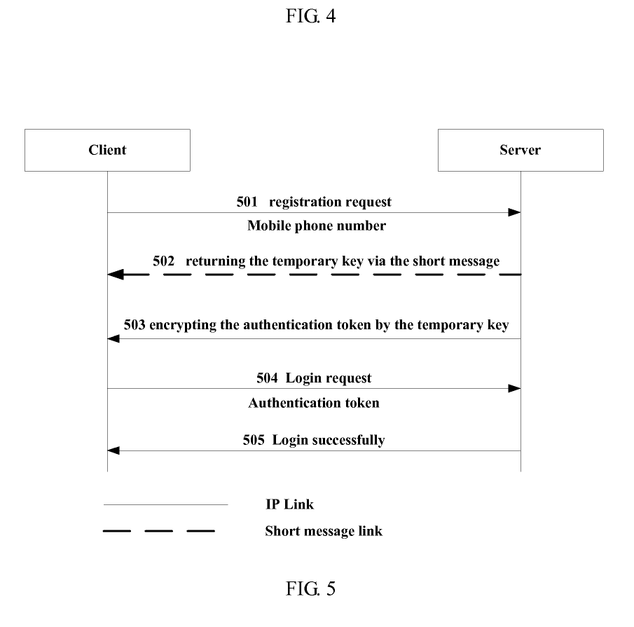

FIG. 5 is a flow chart of another embodiment of registration and login of the mobile phone client in accordance with the present disclosure. The flow chart shown as FIG. 5 is substantially same as that of FIG. 2, only differs that the mobile phone client does not send the short message to the server firstly, and the server sends the temporary key to the mobile phone client via the short message of mobile phone client after the server receives the registration or login request from the mobile phone client. The detailed achieving mode also includes a flow chat of the registration of the mobile phone client and a flow chart of the login of the mobile phone client. Steps 501, 502 and 503 show the flow chart of the registration of the mobile phone client, and steps 504, 505 show the flow chart of the login of the mobile phone client.

The flow chart of the registration of the mobile phone client includes the following steps.

In step 501, the mobile phone client sends a registration request to the server, and the registration request includes a mobile phone number.

In step 502, the server sends a temporary key to the client via short messages of the mobile phone client.

In step 503, the server sends the authentication token encrypted by the temporary key to the mobile phone client.

The flow chart of the login of the mobile phone client includes the following steps.

In step 504, the mobile phone client sends a login request to the server, and the login request includes the authentication token.

In step 505, the server informs the mobile phone client to login successfully.

The defect of the automatic switching communication method is that there is a risk that the server may receive rubbish short message from malicious users.

After success of the login of the mobile phone client, the TCP/SSL link is in an idle status to save energy of the battery of the mobile phone client. The mobile phone client sends a data packet per 15 minutes to the server to keep the TCP/SSL link open. According to the networks of different operators, the time interval of sending the data packet may be delayed to save electricity to delay standby time of the mobile phone client, or the time interval may be shorten properly to ensure the TCP/SSL link open. Once the mobile phone client tests the TCP/SSL link is suspend, the mobile phone client actively establishes the TCP/SSL link again to ensure the TCP/SSL link open. The open TCP/SSL link is defined as the push channel in the present disclosure.

In step two, a sending client sends message to a receiving client.

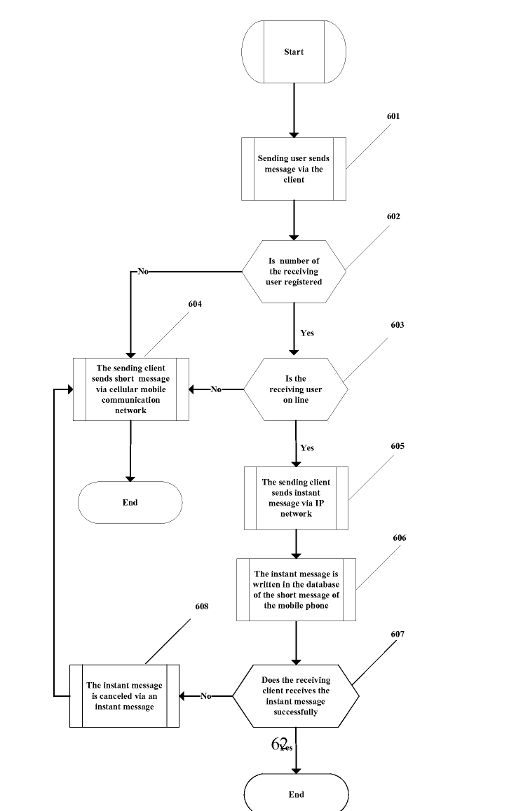

FIG. 6 is a flow chart of the sending client sending message. The flow chart of the sending client sending message includes following steps.

In step 601, a sending user selects to send a message via the sending client. In detail, the sending user selects mobile phone numbers of the mobile phone client to receive the message on the mobile phone client.

In step 602, the sending client determines whether the mobile phone number of the receiving client is registered.

In step 603, the sending client determines whether the receiving client is online, if the mobile phone number of the receiving client is registered.

In step 604, the sending client sends a short message via the cellular mobile communication network, when the mobile phone number of the receiving client is not registered

In step 605, the sending client sends an instant message via the IP network, when the receiving client is online. In detail, the sending client sends the instant message to the server; the server transfers the instant message to the receiving client. The instant message includes the account of the receiving client that is the mobile phone number of receiving client.

In step 606, the instant message is written in a sent message sheet of the database storing short messages of the mobile phone client. So that other clients with short message can look up the instant message, as well as the short messages.

In step 607, the sending client determines whether the receiving client receives the instant message. When the receiving client receives the instant message, the flow chart of the sending client sending message to the receiving client is end. There are many reasons why does the receiving client not receive the instant message, such as the instant message cannot be sent to the server, the instant message cannot be transferred to the receiving client by the server, the receiving client is offline during the sending process of the message, and the sending client does not receive the confirmation from the receiving client in the set time.

In step 608, the sending client cancels the instant message, when the receiving client does not receive the instant message. In detail, the sending client reminds the sending user the sending failure of the instant message, and inquiries the sending user whether the instant message is sent via the short message of the mobile phone client. If the sending user selects to send the instant message by the short message, the flow chart of the sending client sending message to the receiving client returns to the step 604, and the sending client sends the instant message by the short message of the mobile phone.

In step three, the user receives message from the mobile phone.

When the mobile phone client is online, the mobile phone client keeps the TCP/SSL link with the server, which defines as the push channel. When the server receives instant messages of the mobile phone client sending from other clients, the server sends the instant message to the mobile phone client via the TCP/SSL link, which defines push. When the mobile phone client receives the instant message, the mobile phone client informs the server, and the server informs the sending client to send successfully. The mobile phone client reminds the user to receive a new short message, and writes the new short message to the database storing the short message of the mobile phone. The user also can browse the new short message by use of other short message client. So that, for the user, there is no difference between the instant message and the short message. It is not necessary for the user to know whether the message is transferred via the short message of the mobile phone or via the instant message of the IP network.

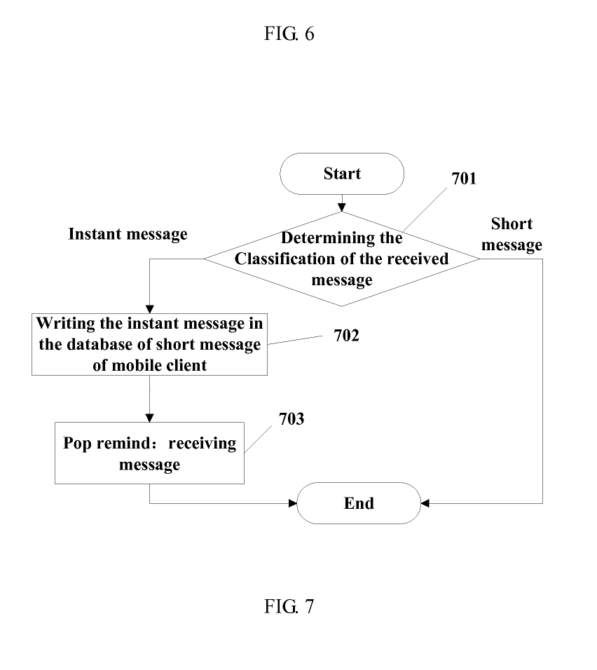

FIG. 7 is a flow chart of the receiving user receiving message from the mobile phone client. The flow chart includes following steps.

In step 701, the receiving client determines the classification of the message, and if the message is a short message, the flow chart of the receiving user receiving message from the mobile phone client is end.

In step 702, the message is written to the database storing the short message of the mobile phone, if the message is an instant message.

In step 703, the user is reminded to receive the message.

In step four, the client uploads the short message.

When the user is offline, the mobile phone client receives the short message transferred from the short message center of a mobile operator. The mobile phone client uploads the short message to the database of the server as a message history record for the user. If the mobile phone client cannot link to the IP network this moment, the mobile phone client uploads the short message to the database of the server when the mobile phone client links to the IP network. The server automatic records the message sent via the IP network, without uploading by the mobile phone client.

An uploading way of multimedia message is completely similar with that of the short message, the multimedia message includes voice communication of users, records of the voice communication, time of the voice communication, time span of the communication, whether the user answers the voice communication.

In step five, the user browses the history of a chat on the web.

A web is an independent part of the automatic switching system of the present disclosure. The user can select to use the web. If the user using the web is required to set a password on the mobile phone client, the password is sent to the server. When the user logins on the web, the user enters the mobile phone number and the password. The server verifies the entered password consistence with the password uploaded by the mobile phone client. After verification of the entered password of the user, the server returns all the message history records of the user to the user, including the instant message and the short message.

The user is capable of sending the instant message to a contact person online on the web. At this moment, the web is configured to be a web client, and the web client sends the instant message to the contacts online via the push channel between a website and the server. The web client cannot send short message to contacts offline.

The web is also capable of browsing, sending and receiving the multimedia message. And the flow chart of browsing, sending and receiving the multimedia message is completely similar with that of the short message. And the web is also capable of browsing the communication records, dialing and receiving a voice communication. The way of browsing communication records is completely similar with that of the message. The user is capable of dialing the voice communication based on the IP network to the online users by use of the web client, and answering the voice communication based on the IP by use of the web client.

In step six, the information of the online contacts is updated in instantaneously.

The automatic switching system of the present disclosure is capable of updating the online information of the contacts for the user.

When the user sends the short message, the automatic switching system of the present disclosure is capable of reminding the user whether the short message generates short message fee. If both of the sending user and the receiving user are online, the message is free, and is sent by the instant message web. If the sending client or the receiving client is offline, and the message generates fee, and is sent by the short message web of the mobile phone client. In order to know by which network is the message sent, it is necessary to know the online status of an opposite side user. Therefore, the mobile phone client is required to locally maintain the online status of the contacts on the phone book, and updates the frequently-used telephone number.

When the client starts up, the mobile phone client adds all the mobile phone numbers on the phone book of the mobile phone client, and all the mobile phone numbers to which the mobile phone client sends message, all the mobile phone numbers from which the client receives message, all the mobile phone numbers that the client dialing or answering, as the contacts. The server returns status of all the contacts to the mobile phone client, such as whether the mobile phone number of the contact person registers on the server, whether the contact person is online. If the status of the contacts is changed, such as one contact person is on line midway, the server informs the mobile phone client via the push channel of the TCP/SSL link. So that the mobile phone client can get the real-time updated online status of the contacts.

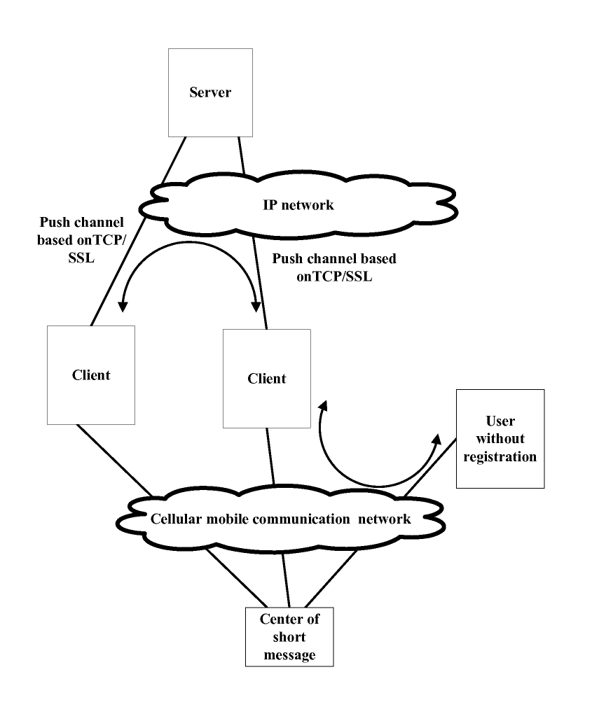

FIG. 8 is a schematic diagram of a short message communication between online clients and a short message communication between the online clients and users without registration in accordance with the present disclosure.

The automatic switching system of the present disclosure is configured for receiving or sending multimedia messages. The sending step of the multimedia messages is completely similar with that of the short messages.

The automatic switching system of the present disclosure is further configured for voice communication. The dialing steps of a telephone are substantially similar with the sending steps of the short message. If the sending client is on line, the server checks if the mobile phone number of the receiving client registers voice communication function, and whether the receiving client is online. If the mobile phone number of the receiving client is registered and is online, the sending client dials voice over Internet Protocol (VoIP), and the mobile phone number is regarded as an identifier of the account. If the mobile phone number of the receiving client is not registered or the mobile phone number of the receiving client is registered but is offline, the sending client accesses a phone module of the mobile phone of the sending client, and dials the mobile phone number of the receiving client via the cellular mobile communication network. A signal of the IP voice communication transferred from the server is established, and the transmission of the actual voice data is transferred by the server, or the actual voice data is transmitted by the point to point mode.

The answering steps of a telephone are substantially similar with the sending steps of the short message. If the receiving client receives the voice communication via the cellular mobile communication network, the receiving client carries out acquiescent steps of the voice communication of the mobile phone, such as the bell is sound to remind the user to answer. If the receiving client receives the voice communication based on the IP network, the receiving client reminds the user to answer the voice communication, and the user answers the IP voice communication according to the user's requirement. After the voice communication is finished, the mobile phone number of the sending client also called IP voice service account, time of the voice communication, and time span of the voice communication are written to the database storing the answered voice communication and the unanswered voice communication. So that, other voice communication client of the mobile phone number can look over the above information. In addition, it is not necessary for the user to know whether the voice communication is transmitted by the cellular mobile communication network or the IP network, because the representation of the voice communication via the cellular mobile communication network is similar with the representation of the voice communication via IP network.

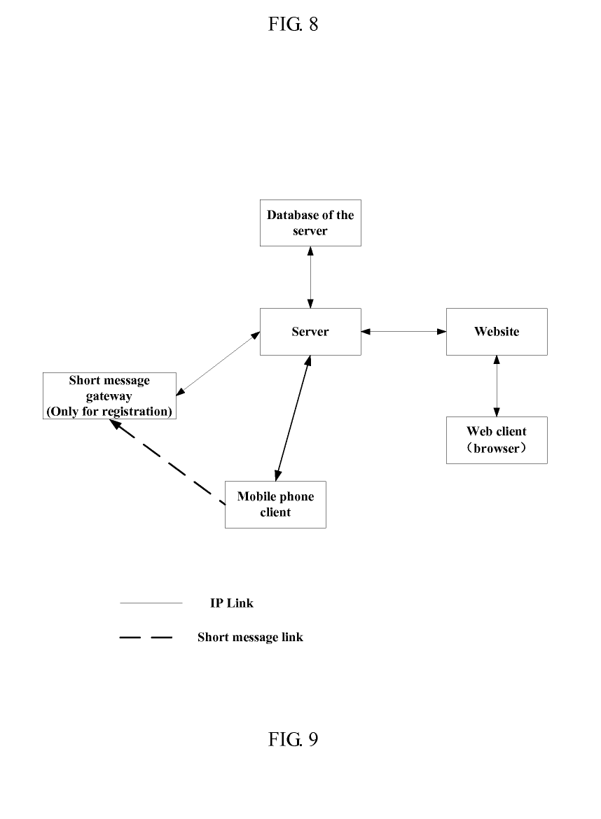

FIG. 9 is a schematic diagram of another embodiment of the automatic switching communication system based on the cellular mobile communication network and the IP network in accordance with the present disclosure. In the embodiment, the automatic switching system includes a server, a mobile phone client, a website, a web client, a database of the server and a short message gateway. The server is connected with the database of the server, the mobile phone client, the short message gateway and the website via an IP link. The website and the web client are connected with each other via the IP link. The mobile phone client and the short message gateway are connected with each other via a short message link. The mobile phone clients communicate with each other by short message or by instant message. The mobile phone client registers on the server via the short message gateway, the server gives the mobile phone client an authentication token, and the mobile phone client logins on the server by use of the authentication token. The short message and the instant message between the mobile phone clients are stored in the database of the server. The user can browses the history records of the message stored in the database of the server on the website via the web client. The corresponding relationship between the temporary key and the mobile phone number and the corresponding relationship between the authentication token and the mobile phone number are stored in the database of the server.

The mobile phone number is used as the user name in the automatic switching system of the present disclosure, because the ascription of the mobile phone number is generally exclusive. When the user name is selected, the trouble that the user name is occupied by other users is avoided. When the user sends the message, it is not necessary for the user to remember extra user names except the mobile phone number of the opposite side user.

When the user use the automatic switching system of the present disclosure for the first time, the mobile phone client automatically tests the mobile phone number of the user, and automatically registers on the server. It is not necessary for the user to entering the mobile phone number of the user. The mobile phone client runs and logins automatically, when the client starts up every time after the first time, without operation of the user.

When the mobile phone client of the present disclosure starts up, the mobile phone client automatically adds all of the mobile phone number in the phone book of the mobile phone of the user as the contacts. When the mobile phone number in the phone book is changed, the mobile phone client adds the corresponding changed mobile phone number as the contact person. In addition, the mobile phone number to which the user sends message or that the users dials, the mobile phone number from which the user receives message or the user answers are added to the phone book as the contacts automatically.

If the user keys the mobile phone number on the mobile phone client directly, does not select the mobile phone number from the phone book of the mobile phone client, the mobile phone client adds the mobile phone number as the contact person automatically when the user select to send message to the mobile phone number or when the user leaves the input box.

When the user wants to send the message, the mobile phone client automatically selects the sending way of the message according to the status of the mobile phone number of the opposite side user. If the opposite side user registers and is online, the message is sent via the instant communication network. If the opposite side user does not register or the opposite side user registers but is not online, the message is sent via the cellular mobile communication network and the center of the short message.

If the identifier of the account corresponding to the mobile phone number of the opposite side user does not register, or the opposite side client is off line, or the message sent via the instant communication network is failed, the client sends the message by use of the short message of the mobile phone, and informs the user the message may generate message fee.

The main problem of automatically switching communication is that when the sending client considers that the message fails to be sent to the receiving client, the message is sent to the receiving client again via the short message of the mobile phone. When the receiving client is on line, the receiving client may receive the instant message reduplicate with the short message. In order to solve the problem described above, the mobile phone client marks each message by a Universal Unique Identifier (UUID), and the UUID is sent to the receiving client together with the content of the message. If the message fails to be sent, the mobile phone client sends a deleting message together with the UUID to the receiving client before the automatic switching of the system. If the receiving client receives the reduplicate message, the receiving client waits for about one minute to check if the receiving client receives the deleting message with the UUID. The reduplicate message is not displayed if the receiving client receives the deleting message with the UUID.

The multimedia message, voice communication transmitted by the IP network (Voice over IP, VoIP) can use the mobile phone number as the identifier of the account of the user. Similarly, it is not necessary for the user to register. The mobile phone client registers and logins automatically, adds and manages the contacts automatically. The mobile phone client automatically selects to send the multimedia message via the cellular mobile communication network or via the IP network. The mobile phone client automatically selects to start the voice communication via the cellular mobile communication network or via the IP network. When the IP network fails, the mobile phone client automatically switches to send the multimedia message or start the voice communication via the cellular mobile communication network. The multimedia message sent or received via the cellular mobile communication network, and the voice communication records via the cellular mobile communication network are uploaded to the server, except the multimedia message and the voice communication records via the instant communication network. The messages and the records of the communication can be displayed on the web client.

In comparison with FaceTime, the users applying the automatic switching system of the present disclosure can communicate with a user who does not use the automatic switching system of the present disclosure. Even if the IP network breaks off, it is not necessary for the user to switch into other procedure, the communication are carrying out normally. In addition, the automatic switching system of the present disclosure is configured for sending the short message of the mobile phone, dialing or answering telephone and carrying out the video communication. However, FaceTime is only used for carrying out the video communication. It is convenient for the user using the automatic switching system of the present disclosure to send or receive message, dial or answer telephone on the web when the users uses the computer. In addition, FaceTime only use the IP network for communication. The automatic switching system of the present disclosure can automatically select one of the IP network and the cellular mobile communication network for communication.

In comparison with Fetion of China Mobile, it is not necessary for the user applying the automatic switching system of the present disclosure to register, search, invite and add friends. When the receiving client is off line, the instant message of Fetion of China Mobile can be changed to the short message of the mobile phone, but it is useless when the receiving client does not access the network. In addition, when the sending client of Fetion of China Mobile sends message to the receiving client via the short message, the receiving client displays a system number of a well-know contact person, not a mobile phone number of the well-know contact person, and the mobile phone client cannot display the name of the contact person automatically. There is no difference between the message sent or received via the automatic switching system of the present disclosure and the short message of the mobile phone, and the mobile phone client of the present disclosure can normally display the mobile phone number and the name of the sending user.

Wechat of Tencent is substantially similar with Fetion of China Mobile. In comparison with Wechat of Tencent, it is not necessary for the user applying the automatic switching communication system of the present disclosure to register the account, search and add friends. The present disclosure is also used for video communication and telephone communication.

In comparison with Google Voice, the existing mobile phone number of the user of the present disclosure is regarded as the identifier of the account of the user. The automatic switching communication system of the present disclosure does not distribute a new mobile phone number as the identifier of the account of the user, and the client of the present disclosure registers and logins automatically, without the operation of the user. By using the present disclosure, the instant message and the short message of the mobile phone are sent to the opposite side user by one number, not two different numbers, which avoids confusion for the opposite side user.

The innovations of the present disclosure relative to the prior arts are shown as following sheet.

| | | | Fetion of | |
|---|---|---|---|---|
| | The present | Apple | China | Google |
| | disclosure | Facetime | Mobile | Voice |
| The existing mobile phone number of | Yes | No | No | No |
| the user is provided as the identifier of | | | | |
| the instant message, the client registers | | | | |
| and logins automatically. | | | | |
| The existing mobile phone number of | Yes | No | No | No |
| the user is provided as the identifier of | | | | |
| the IP voice communication, the client | | | | |
| registers and logins automatically. | | | | |
| The existing mobile phone number of | Yes | Yes | No | No |
| the user is provided as the identifier of | | | | |
| the video communication, the client | | | | |
| registers and logins automatically. | | | | |
| When the user selects to send a short | Yes | No | The client | No |
| message or dial a telephone, the client | (The | | can | |
| automatically selects one of the instant | message is | | automatically | |
| communication network and the cellular | sent by the | | select | |
| mobile communication network to send | client | | according to | |
| the short message or dial the telephone, | directly, | | the online | |
| according to whether the sending client | without | | status of the | |
| is connected to the network and the | transfer of | | sending | |
| online status of the receiving client. | the server.) | | client, and | |
| | | | the sending | |
| | | | client | |
| | | | without | |
| | | | connection | |
| | | | with the | |
| | | | network can | |
| | | | not send | |
| | | | message. | |
| | | | the short | |
| | | | message is | |
| | | | sent by the | |
| | | | server, not | |
| | | | by the | |
| | | | client. | |
| When the instant message fails to send | Yes | No | No | No |
| out, the client automatically switches to | | | | |
| send the short message to the mobile | | | | |
| phone again. | | | | |
| The storing way for the instant message | Yes | No | No | No |
| received by the client is same as that of | | | | |
| the short message, and there is no | | | | |
| difference between the instant message | | | | |
| sent or received by the present | | | | |
| disclosure and the short message of the | | | | |
| mobile phone. | | | | |
| The instant message and the short | Yes | No | No | No |
| message of the mobile phone are sent by | | | | |
| the same number, and there is no | | | | |
| difference between the instant message | | | | |
| sent by the present disclosure and the | | | | |
| short message of the mobile phone. | | | | |
| The voice communication based on the | Yes | No | No | No |
| IP network and the telephone | | | | |
| communication of the mobile phone | | | | |
| uses the same number, there is no | | | | |
| difference between the communication | | | | |
| records dialed or answered by the | | | | |
| present disclosure and the telephone | | | | |
| communication of the mobile phone. | | | | |
| The client automatically adds the | Yes | No | No | No |
| persons who sends the short message to | | | | |
| the client or who receives short message | | | | |
| from the client as the instant | | | | |
| communication persons. | | | | |
| The client automatically adds persons | Yes | No | No | No |
| who answers the telephone from the | | | | |
| client or who dials the telephone to the | | | | |
| client as the instant communication | | | | |
| persons. | | | | |
| When the user sends messages, the user | Yes | No | No | No |
| is reminded whether the message | | | | |
| generates message fee (the message is | | | | |
| sent via the instant communication | | | | |
| network or via the cellular mobile phone | | | | |
| communication network) | | | | |
| If the free message sent via the instant | Yes | No | No | No |
| communication network fails to be sent | | | | |
| out, the user is reminded to use the | | | | |
| cellular mobile phone communication | | | | |
| network to send the fee message. | | | | |
| When the user dials voice | Yes | No | No | No |
| communication, the user is reminded | | | | |
| whether the voice communication | | | | |
| generates fee (the voice communication | | | | |
| is dialed via the instant communication | | | | |
| network or via the cellular mobile phone | | | | |
| communication network) | | | | |
| If the free voice communication dialed | Yes | No | No | No |
| via the instant communication network | | | | |
| fails, the user is reminded to use the | | | | |
| cellular mobile phone communication | | | | |
| network to send the fee voice | | | | |
| communication. | | | | |
| If the free video communication via the | Yes | No | No | No |
| instant communication network fails, the | | | | |
| user is reminded to use the cellular | | | | |
| mobile phone communication network | | | | |
| to send the fee voice communication, | | | | |
| but without video. | | | | |
| The message sent or received by the | Yes | No | No | No |
| user via the short message of the mobile | | | | |
| phone are automatically uploaded to the | | | | |
| server by the client, except the instant | | | | |
| message, and the user can browses the | | | | |
| uploaded message on the web client. | | | | |
| When the client receives the message | Yes | No | No | No |
| sent by the web client, the mobile phone | | | | |
| number of the user is displayed, which | | | | |
| results that there is no difference | | | | |
| between the short message of the mobile | | | | |
| phone and the message from the web | | | | |
| client. | | | | |

While various embodiments and methods of the present disclosure have been described above, it should be understood that they have been presented by way of example only and not by way of limitation. Thus the breadth and scope of the present invention should not be limited by the above-described embodiments, but should be defined only in accordance with the following claims and their equivalents.

1-38. (canceled)

39. A communication method for automatically switching between cellular networks and IP networks, the method comprising:
using a full or partial mobile phone number or a result calculated from the full or partial mobile phone number as an identifier of a client or an user account or a part of the identifier of the client or the user account; and
a sending user inputting or selecting the user account or the mobile phone number of a receiving user on a sending client to send a message to the receiving user, wherein if there is an user account corresponding to the mobile phone number of the receiving user registered on a server and the user account is on line, the sending client sends a message to the server via the IP networks, and the server transfers the message to a receiving client via the IP networks; or the sender's client sends the message directly via the IP networks to the receiving client; and wherein if there is no user account corresponding to the mobile phone number of the receiving user registered on the server or the user account is registered but offline, the sending client directly sends a short message to the mobile phone number of the receiving user via the cellular networks.

40. The communication method as claimed in claim 39, between the step of using the full or partial mobile phone number or the result calculated from the full or partial mobile phone number as the identifier of the client or the user account or the part of the identifier of the client or the user account and the step of the sending user inputting or selecting the user account or the mobile phone number of the receiving user on the sending client to send the message to the receiving user further comprising steps of
the client registering or logging on the server automatically;
the client determining whether there is an authentication token, and whether there is an user account corresponding to the mobile phone number of the client on the server;
the client using the authentication token to log in the server, when the client has an authentication token;
the client sending a registration request to the server, and receiving the authentication token in response from the server, when the client has no authentication token and the server has no user account corresponding to the mobile phone number; and
the client authenticating with the server using SMS service over the cellular networks and recovering the authentication token, when the client has no authentication token but the server has an account for the mobile phone number.

41. The communication method as claimed in claim 39, wherein alter the receiving client receiving the instant message, the receiving client displays the mobile phone number of the sending user and the content of the message in the same fashion as how the receiving client displays SMS message received via the cellular networks.

42. The communication method as claimed in claim 39, before the step of the sending client sending the short message to the receiving client via the cellular networks, further comprising following steps:
the sending client determining whether the message is sent as short message via the cellular networks; and
the sending client reminding the sending user whether sending message generates message fee accordingly.

43. The communication method as claimed in claim 39, wherein the sent short messages or the received short messages are uploaded to the database of the server via the IP networks, and wherein when a mobile client of the sending user or the receiving user can not access to the IP networks, the client stores the uploading short message, and maintains an order for the uploading short message, and uploads the uploading short message to the server when the mobile terminal accesses to the IP networks.

44. The communication method as claimed in claim 43, wherein the server records the instant message transferred through the server, and stores the instant message transferred through the server and the short message uploaded from the clients as message history records.

45. The communication method as claimed in claim 44, wherein a website is connected to the server via the IP networks, and the sending user sends instant message to the receiving user who has registered on the server and is on line via a web client, and wherein the user can view the message history records in the database of the server via a browser of the website or the client.

46. The communication method as claimed in claim 39, wherein the client updates online information of the contacts instantaneously.

47. The communication method as claimed in claim 39, wherein the sending client and the receiving client can carry out a voice communication or a communication with multimedia messages on the IP networks.

48. The communication method as claimed in claim 47, wherein the sending client or the receiving client uploads the voice communication record and the data of multimedia message to the database of the server.

49. The communication method as claimed in claim 47, wherein transmission of voice communication data between the sending client and the receiving client is transferred through the server over the IP networks, or the voice communication data between the sending client and the receiving client is transmitted directly over the IP networks.

50. An automatic switching communication system between cellular networks and IP networks, the communication system comprising clients and the server, the clients comprising a sending client and a receiving client;
wherein the client is configured for sending an instant message to the server when a receiving user has registered on the server and is on line; or is configured for sending a short message to the mobile phone number of the receiving user when the receiving user has not registered on the server or the receiving user has registered on the server, but the receiving user is offline;
wherein the server is configured for transmitting the instant message to the receiving client;
and wherein a full or partial mobile phone number or a result calculated from the mobile phone number is provided as an identifier of the client or a part of the identifier of the client.

51. The communication system as claimed in claim 50, when the sending client fails to send the message via the server, the sending client reattempts to send the message directly to the receiving client via the cellular networks.

52. The communication system as claimed in claim 50, wherein the client automatically registers and adds the mobile phone number as contacts, or the client automatically logins on the client and adds mobile phone number as contacts; and wherein a push channel is established between the client and the server on the IP networks.

53. The communication system as claimed in claim 50, wherein the client is further configured for displaying a mobile phone number of a sending user with a displaying mode similar with a displaying mode of the received short message, after the client receives the instant message.

54. The communication system as claimed in claim 50, wherein the client is further configured for establishing an encrypted IP communication link with the server, and the client and server certificates with the server.

55. The communication system as claimed in claim 50, wherein the client is configured for determining whether there is an authentication token; and wherein the client sends a registration and login request to the server if there is no authentication token, and the client logs on the server if there is the authentication token.

56. The automatically switching system as claimed in claim 55, wherein the client is further configured for sending the short message to the server via the cellular mobile communication network when the client requests registration on the server, and wherein the short message comprises a temporary key; and the client is configured for sending a registration request to the server via the IP networks, and wherein the registration request comprises the mobile phone number; and the client is further configured for certificating with the server; and the client is configured for receiving encrypted authentication token transmitted from the IP networks and getting the authentication token by decrypting the encrypted authentication token; and wherein the authentication token is accessed or generated by the server and corresponds to the mobile phone number, and the server encrypts the authentication token by the temporary key; or
the client is further configured for sending the registration request to the server via the IP networks when the client requests registration on the server, and wherein the registration request comprises the mobile phone number; the client is further configured for receiving the short message transmitted from the server via the cellular mobile communication network, and wherein the short message comprises the temporary key; and the client is configured for certificating with the server; and the client is configured for receiving the encrypted authentication token and decrypting the encrypted authentication token by the temporary key to get the authentication token; and wherein the authentication token is accessed or generated by the server and corresponds to the mobile phone number, and the server encrypts the authentication token by the temporary key.

57. The communication system as claimed in claim 55, wherein the server is configured for verifying the authentication token consistence with a digital signature of a certificate of the client with an encrypted connection with the server, and agreeing the certification of the client, verifying the authentication token, and informing the client to login successfully.

58. The communication system as claimed in claim 50, wherein the client is configured for writing the sent instant message on a sent message sheet of the database storing the short message of the mobile phone, and writing the received instant message on a received message sheet of the database.

59. The communication system as claimed in claim 50, wherein the client is configured for reminding the sending user whether sending message generates message fee before the sending client sending message to the receiving client via the cellular networks.

60. The communication system as claimed in claim 50, further comprising a database embedded in the server, and the client is configured for uploading the sent short message and the received short message to, the database via the IP networks.

61. The communication system as claimed in claim 60, wherein the client is further configured for storing the uploading short message, and maintaining an alignment for the uploading short message, when the IP networks is not accessed, and the client is configured for uploading the short message to the server when the IP networks is accessed.

62. The communication system as claimed in claim 61, wherein the database of the server is further configured for recording the instant message transferred from the server, and storing the instant message transferred from the server and the short message uploaded from the receiving client as message history records.

63. The communication system as claimed in claim 62, further comprising a website and a web client, the IP networks are established between the website and the server, and the sending user sends instant message to the receiving user who has registered on the server and is on line via the web client.

64. The communication system as claimed in claim 63, wherein the user can view the message history records in the database of the sewer via a browser of the website.

65. The communication system as claimed in claim 50, wherein after the receiving client received the short message, if the sending user is online, the receiving client is configured for replying to the sending client by use of the instant message, or after the receiving client received the instant message, if the sending user is offline, the receiving client is configured for replying the sending client by use of the short message.

66. The communication system as claimed in claim 50, wherein the client is further configured for instantaneously updating online information of the contacts.

67. The communication system as claimed in claim 60, wherein the client is capable of carrying out a voice communication or a multimedia communication on the IP networks.

68. The communication system as claimed in claim 67, wherein the client is further configured for uploading the voice communication records and the data of multimedia message to the database of the server.

69. The communication system as claimed in claim 67, wherein transmission of voice communication data between the sending client and the receiving client is transferred by the server, or the voice communication data between the sending client and the receiving client is transmitted directly over the IP networks.

70. A communication method for automatically failover process between cellular networks and IP networks, the method comprising:
a sending user sending an message on a sending client to the receiving user over IP networks; and
when the sending client fails to send the message to a receiving client via the IP networks, the sending client reattempting to send the message to the receiving client as short message via the cellular networks.
